(19) United States
(12) Patent Application Publication
(10) Pub. No.: US 2009/0083014 A1
(43) Pub. Date: Mar. 26, 2009

(54) Method for analyzing the reliability of technical installations with the use of physical models

(75) Inventor: Christian Schallert, Munich (DE)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: DEUTSCHES ZENTRUM FUER LUFT-UND RAUMFAHRT E.V.

(21) Appl. No.: 12/231,812

(22) Filed: Sep. 5, 2008

(30) Foreign Application Priority Data
Sep. 7, 2007 (DE) 102007042752.4

(51) Int. Cl. G06G 7/48

(52) U.S. Cl. 703/6

(57) ABSTRACT

A method for analyzing and/or optimizing technical systems, comprising the following steps:
modeling a technical system using a software model,
determining for all relevant combinations of functional and/or failed individual components of the technical system, whether an orderly functioning or a failure of the entire technical system exists, the determination being performed automatically using the software model established,
determining the individual failure probabilities of the components of the technical system,
calculating a total failure probability for the technical system based on the individual failure probabilities of the components of the technical system and on the determined functioning/failure of the entire technical system for the respective functional and/or failed circuit components.

### BACKGROUND OF THE INVENTION

1. Field of the Invention

The invention is directed to a method for analyzing the reliability of technical devices and installations, allowing an analysis and optimization of the same. The method is applicable, for example, to electrical circuits, hydraulic and pneumatic networks as well as mechanical systems, especially the on-board systems of aircraft.

2. Description of Related Art

Various approaches and software programs exist for the physical modeling and simulation of technical systems. Other software programs exist for reliability analysis based, for example, on the fault-tree or block diagram method. In contrast to the physical description, i.e. modeling of technical systems, existing methods and programs for reliability analysis require an abstracted, purely logical description of the functional relations in the technical system.

In the fault-tree method, combinations of failed components in the system that lead to a system failure are identified. The event “system failure” must be defined by the user. The user further has to set up the fault tree correspondingly. A fault tree is made up of all relevant combinations of component failures that lead to a failure of the system in the sense of the definition of this event. The relevant combinations of component failures are also referred to as minimal cut sets. By definition, a minimal cut set is characterized in that it includes no other combination of failed components as a proper subset. In other words: if one or more components of the minimal cut set are assumed as intact, the event “system failure” no longer occurs.

For the block diagram method, combinations of functional components in the system are identified that will lead to the event “system function” (the complementary event to the event “system failure”). The user has to find such combinations of functional components, which are also referred to as minimal path sets, for the event “system function” and set up a reliability block diagram therefrom. By definition, a minimal path set is characterized in that it includes no other combination of functional components as a proper subset. In other words: if one or more components of a minimal path set are assumed as failed, the system is no longer functional.

Using software programs that allow the setting up of either fault-trees or of block diagrams, probabilistic reliability parameters are calculated then. Given a correct and matching abstraction of the system to be analyzed by a fault-tree or by a block diagram, the corresponding software programs calculate equivalent results.

Both methods are suitable for an analysis of complex systems with serial and parallel structures, as well as redundancies. However, the system has to be abstracted in the manner described above. The minimal path sets or minimal cut sets have to be determined and entered into the software program by the user.

Without expansion, both methods are suitable only for the analysis of static systems. “Static” in the sense of reliability analysis means that the system does not include any algorithms or other automatically executed processes for reconfiguration after the failure of one or more components. For a reliability analysis of dynamic systems, such as systems with automatic reconfiguration, the representation of the minimal path sets of a system has to be supplemented with a finite state machine in which the user defines the transition conditions of the system states (Markov process). Especially with safety-critical technical systems, among which also aircraft on-board systems belong, redundancy (multiplication of the function paths) and reconfiguration (automatic switching to bypass failed components) are implemented to augment the functioning of the system. As described above, an analysis and optimization of aircraft on-board systems or similar technical systems is thus possible only with great effort and comprehensive expertise.

The aspects of physical behavior, reliability and weight that are of importance when designing and optimizing technical systems, especially aircraft on-board systems, may be treated using existing methods and software programs. However, the different tools stand alone. This is particularly true for software programs for reliability analysis. The following is an illustration, with reference to FIGS. 1 to 3, of the analysis of technical systems as performed heretofore in prior art. As already explained, the analysis and the optimization of a technical system with respect to different design criteria, e.g. physical behavior, reliability and weight, can be executed only with the help of several standalone methods and software programs. A treatment of an individual one of the various aspects requires another description, i.e. modeling of the system, respectively.

For the reliability analysis explained in the following, the user has to divide the system to be evaluated into minimal path sets (logical function paths) or minimal cut sets (failure combinations) in order to thus set up a fault tree or a block diagram for the system. However, these have another structure as the common and more easily understandable schematic diagrams of the system to be analyzed. Often, only proven specialists in the field of reliability analysis are able to establish or interpret the fault trees, block diagrams and the finite state machines, needed with reconfigurable systems, for a complex system. This exemplary explanation will be given hereunder with reference to FIGS. 1 to 3.

The electric circuit 10 illustrated in FIG. 1 comprises two voltage sources (batteries) B1 and B2, three switches S1, S2 and S3, as well as two lamps L1 and L2. Each lamp is powered by a battery of its own. If, for example, battery B1 should fail, the associated lamp L1 can be powered by the other battery B2 by closing the switch S3. In this case, switch S1 is opened to isolate the failed battery.

In this example, the event “system function” is defined as the case that at least one of both lamps is lit. Accordingly, the complementary event “system failure” means that none of the lights is on.

This example thus refers to a simple electric system with redundancy and automatic reconfiguration.

FIG. 2 illustrates the reliability block diagram for the electric circuit illustrated in FIG. 1 in accordance with the definition of the event “system function”. If at least one minimal path set, i.e. a path from A to B, exists, the system is functional. This is true, for example, when the components B1, S1 and L1 are intact.

FIG. 3 illustrates the corresponding fault tree. The system fails if at least one minimal cut set exists. For example, this is true when the components B1 and S2 have failed.

To establish the reliability block diagram and the fault tree, the electric circuit illustrated in FIG. 1 had to be abstracted with regard to its logical function. Neither the structure of the block diagram in FIG. 2, nor that of the fault tree in FIG. 3 resemble the structure of the circuit in FIG. 1.

Existing tools can be used to calculate reliability parameters, e.g. the system failure probability, from the block diagram and the fault tree. For the further aspects, such as physical behavior or weight, the system has to be examined using other tools. Neither the fault tree, nor the block diagram can be used again in this process.

Especially upon changes in the system, treating the different aspects of a system design with separate methods and tools leads to an increased effort. The effects of a change have to be evaluated with respect to the design criteria, so that the system can be optimized. To achieve this, every change has to be incorporated accordingly into the separate tools. The effort entailed thereby and also the possibilities for errors that may possibly lead to inconsistent results, are comparatively high.

### SUMMARY OF THE INVENTION

It is an object of the invention to provide a method with which technical systems, such as electric circuits, can be analyzed and optimized in a simple manner for design criteria like weight, reliability and physical behavior.

A method for analyzing and optimizing technical systems comprises the following steps:

First, a model of the technical system, e.g. an electric circuit, is established using a physical modeling language. Preferably, this is a physical and object-oriented modeling language, such as Modelica. Modelica is a modeling software offering a variety of component models in which the respective function is described by physical equations. Different from the modeling approaches commonly used in Modelica, the component models preferably used for the novel method not only physically describe the functional behavior but also the behavior in different failure states. In addition, each model preferably also includes a parametric dependence on the mass of a component. The component models thus expanded are comprised in libraries, as usual, and are available for establishing more complex system models.

Alternatively, another modeling software can be used.

According to the invention, it is further defined for which combination of functional or failed individual components of the technical system a full functioning, a degradation and/or a failure of the entire technical system is given. All relevant combinations of functional and/or failed individual components of the technical system, especially various types of failure of the individual components, are taken into account. The state “system function” or “system failure” is preferably defined by the user, specifically in the model of the technical system, by inserting suitable model components, such as sensors for electric voltage or current.

According to the invention, the full functioning, the degradation or failure of the system is determined by an automated minimal path set analysis or a minimal cut set analysis, wherein all relevant combinations of functional or failed individual components are run through automatically in a simulation of the physical model of a technical system. Accordingly, the automated minimal path set analysis or the minimal cut set analysis resembles a systematic search method of the “trial and error” type. The automated search methods for the determination of the minimal cut sets and the minimal path sets of a technical system are preferably implemented in a mathematic-technical programming language such as Matlab. The determination of the functioning or failure of the system is preferably performed by an analysis software which has access to the software model of the technical system.

Alternatively, another programming language may be used.

According to the invention, a method is thus provided that allows for a simple analysis and optimization of design criteria such as weight, reliability and physical behavior of technical systems under varying operating conditions. In particular, the method of the invention provides a means for a simple and automatic determination of the reliability of a technical system from a physical model of the system. Thus, the invention forms the base of the development of an integrated software that can be used to analyze and optimize technical systems, such as an electric on-board network of an aircraft, with respect to the above design criteria. In particular, due to the invention, only one model has to be established or modified for the analysis of a technical system with respect to the above design criteria, thereby achieving a reduced effort and a better consistency of the results.

It is particularly preferred for the implementation of the automated minimal cut set analysis method and the minimal path set analysis method to have an interface to the physical model of the technical system. The interface between the modeling software Modelica and the programming language Matlab allows for automated simulations of the system model as well as for the exchange of model input parameters, e.g. to predefine the functional or failure states of the individual components in the system model, and of simulation results, such as the functioning, the degradation or the failure of the modeled technical system.

According to the invention, each individual component of the model includes a failure probability. Preferably, typical numerical values for the individual failure probabilities are automatically preset. For example, the user may also use other values, if need be, which he will enter in the individual components of the physical model of a technical system. The individual failure probabilities are read automatically by the reliability analysis method via the above described software interface.

Thereafter, a total failure probability is calculated—preferably automatically—for the technical system, e.g. an electric circuit. This is done on the basis of the individual failure probabilities of the components of the technical system and the minimal path sets determined for the functioning or the degradation or the minimal cut sets determined for the failure of the entire technical system.

For the calculation of the probability of the failure or the functioning of the total system, the method preferably determines the so-called orthogonalization of the minimal cut sets or minimal path sets determined in previous step. This refers to the intersections of the first, second, third order etc. of the minimal cut sets or minimal path sets. According to Boole's idempotent law components occurring several times in the respective intersections are considered only once. The probability of a failure or the functioning of the system is calculated from the sum of the probabilities of occurrence of the intersections formed by minimal cut sets or minimal path sets, wherein intersections of odd order are added and intersections of even order are subtracted. This step can also be comprehended from the calculation equations in the present application.

In addition or as an alternative to the calculation of the probability of a total failure of the technical system, one may also calculate the importance of the individual components of the technical system, such as an electrical circuit. The importance of a component in the overall system is a measure of the structural and probabilistic influence of this component with respect to the occurrence of a system failure. Thus, it can be determined from the calculated importances of the individual components where the system analyzed has potential weaknesses or unnecessary redundancies. The calculation of importance parameters is also based on the above described orthogonalization of the minimal cut sets or minimal path sets. This step can also be comprehended from the calculation equations in the present application.

The calculation of the total failure probability may be based, for example, on the result of a minimal cut set analysis, in particular an automated minimal cut set analysis. As an alternative or in addition, the calculation of the total failure probability can be based on the result of a minimal path set analysis, in particular an automated minimal path set analysis. These steps may also serve to calculate the importance of the individual components of the technical system.

In a preferred embodiment, a minimal cut set analysis is used to determine all relevant, especially all possible combinations of dysfunctional individual components of the technical system that cause a failure of the system, the determination of the functioning/failure of the overall system preferably being done using a systematic search method of the “trial and error” type. This is an automated minimal cut set analysis.

Within the framework of the minimal cut set analysis, the probabilities of the occurrence of the determined combinations of dysfunctional individual components, i.e. of the minimal cut sets that cause the failure of the system, are calculated. This is done based on the known failure probabilities of the individual components.

Likewise, in the automated minimal path set analysis, all possible combinations of functional individual components are determined that lead to the functioning or at least a degraded functioning of the overall system. Here, the minimal path set analysis comprises the following step:

calculating the probability of the occurrence of the determined combinations of functional individual components leading to the functioning of the overall system.

Preferably, the physical modeling of the technical system, such as an electric circuit, is done in an object-oriented modeling software. Here, the object limits and the connections between the objects in the software model correspond to the actual individual components and their connections in the real system.

The minimal cut set analysis and/or the minimal path set analysis are preferably performed by an automated analysis program. The analysis program may be implemented in Matlab, for example. This is a mathematic-technical programming language by means of which the method steps mentioned can be implemented.

It is particularly preferred that the software for performing the automated minimal cut set analysis and the minimal path set analysis comprises an interface to the modeling software with which the model of the technical system is established.

It is particularly preferred that the object-oriented modeling software for establishing the model of the technical system, such as an electric circuit, comprises a graphical user interface for the visible representation of the modeled system. Thereby, the system model can be modified via the graphical user interface. For example, the position of an individual component in the system can be changed. Further, individual components and connections can be added or removed and switching logics can be set up graphically.

It is particularly preferred that, when the system and the corresponding model are modified, a recalculation of the minimal cut set analysis and/or the minimal path set analysis as well as a new execution of the steps following the minimal cut set analysis and/or the minimal path set analysis will be performed “at the push of a button”. Thus, upon frequent modifications of technical systems, new reliability parameters, especially the total failure probability and the importance of individual system components can be calculated automatically and with little effort. Therefore, this method offers the advantage that an optimization of a technical system is also available to persons that do not have comprehensive mathematic or programming knowledge. In particular, it is no longer necessary to perform an abstraction of the technical system in the sense of block diagrams or fault trees.

The software for modeling the technical system preferably performs an automated calculation of the total mass of a system from the individual masses of the individual components. This step is relevant, for example, in optimizing on-board systems in aircraft, since these are systems in which weight is an important criterion.

Moreover, the software for modeling the technical system may be used to run a simulation of its physical behavior. Thus, it can be determined dynamically how modifications in the system or in the operating state, which can be made in the modeling and simulation software, work on the functionality of the system.

The invention particularly refers to the implementation of a method for analyzing and optimizing technical systems, and especially of the method described above, in analyzing and optimizing aircraft on-board systems.

The invention further relates to a data carrier holding software for performing the above described method.

### BRIEF DESCRIPTION OF THE DRAWINGS

The following is a detailed description of preferred embodiments of the invention with reference to the Figures.

FIGS. 2 and 3 explain the reliability analysis as of prior art, using a manually established block diagram and a fault tree for the electric circuit illustrated in FIG. 1.

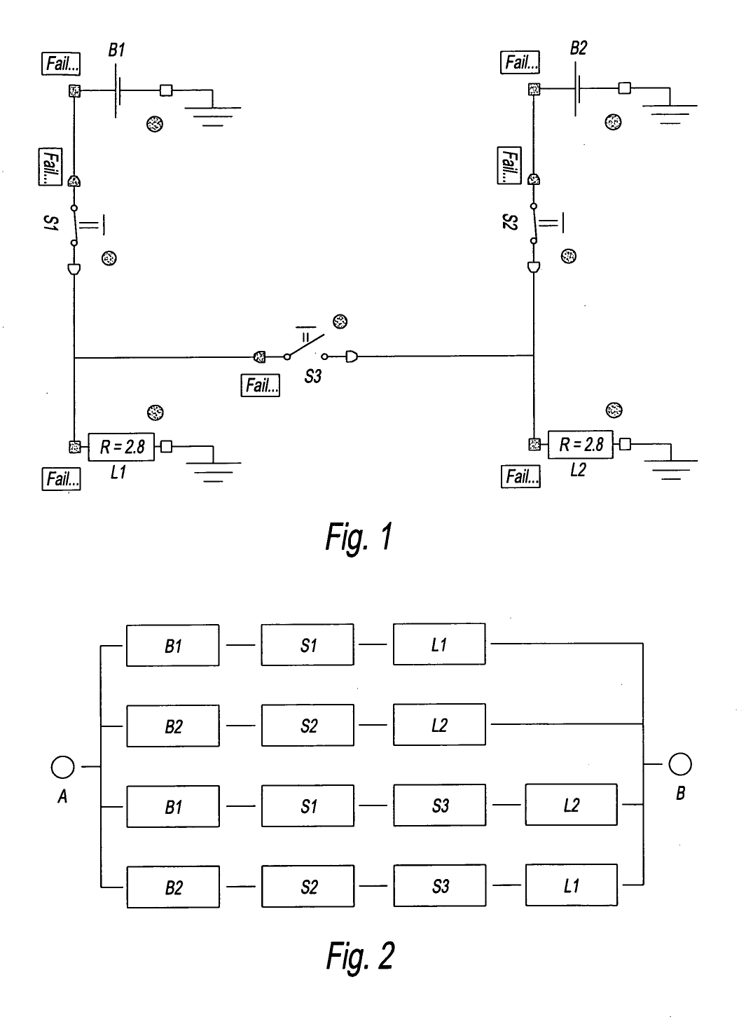

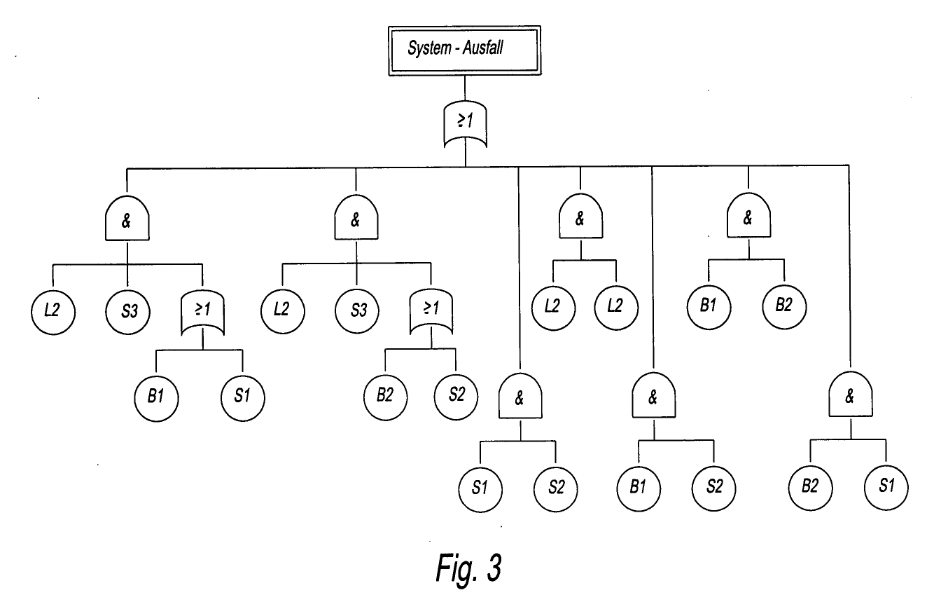

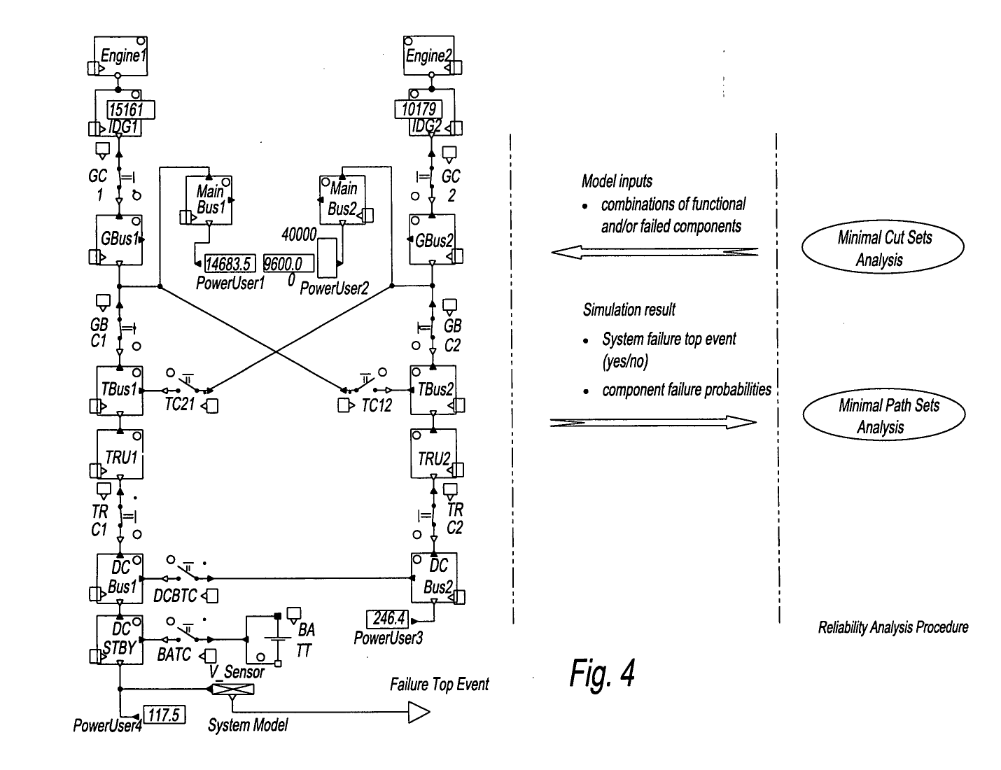

Further, FIG. 4 is a schematic conceptual illustration of the reliability analysis using a physical system model. As illustrated in FIG. 4, the present method may be implemented, for example, using the object-oriented physical modeling language Modelica (see left side of FIG. 4) and the mathematic-technical programming language Matlab (see right side of FIG. 4).

### DETAILED DESCRIPTION OF PREFERRED EMBODIMENTS

In the present method, the component models partly available in Modelica model libraries are expanded such that, besides the functional behavior, also the respective behavior in the failure state is described by physical equations. Depending on the type of component, the expanded physical modeling takes into account one or more different failure states as well as the respective probabilities of their occurrence. For example, there are two types of failure for a simple electric conductor, namely “loss of conductivity” and “short-circuit to ground”. In the present additional modeling of the failure behavior, consideration has to be given, among other things, to the compatibility with other component models. This is important so that system models, which are usually built from a plurality of component models, can readily be simulated for all possible combinations of intact and failed components. Using a system model, this expanded modeling approach allows to simulate the system's behavior in the fully functional state as well as in degraded or failure states.

In the method presented, the component models are additionally expanded by a parametric description of the respective mass. With this expansion, the mass of a component is calculated in each component model in dependence on parameters defining the dimensions thereof. For example, with an electric generator, the nominal power, voltage and rpm are the dimensioning parameters on which the mass of the generator depends. These parameters can be entered by the user into the respective component model. As an alternative, the user may also directly enter a numerical value for the mass of a component in the respective model.

The method of reliability analysis links up with the above described modeling of the behavior of components in the functional and the failed states:

In one procedure, a simulation of the system model 12 is used to verify for combinations of intact or failed components, whether the system 10 remains functional or fails. In doing so, combinations of failed or intact components are run through in a defined order described hereinafter. The procedure is of the systematic “trial and error” type.

The procedures of the reliability analysis are preferably implemented in Matlab 14 and, via an interface, have access to the system model 12 implemented in Modelica, for example.

If the system fails for a combination of one, two, three etc. failed components, this combination will be stored in the procedure as a minimal cut set. If the system is functional for a combination of one, two, three or more functional components, this combination will be stored as a minimal path set.

Preferably, a so-called orthogonalization of the minimal cut sets or minimal path sets is performed so that the procedure will thereafter calculate the system failure probability as well as the importance of the individual system components.

As illustrated in FIG. 4, the reliability analysis method, which is implemented in the programming language Matlab, for example, includes a transfer of combinations of intact and/or failed components to the system model 12. In return, the latter supplies a simulation result including the information whether the combinations of system components transmitted represent a defined system failure or not. Further, the system model 12 transmits the individual failure probabilities of the components of the electric circuit 10 to the software 12.

The following will be a description of the automated search method for determining the minimal cut sets of a system. The explanation of the procedure will be based on the example in FIG. 1. Typically, minimal cut sets will be determined up to the third order, since beyond that, the probability of their occurrence generally decreases drastically and for this reason, minimal cut sets of higher orders need not be taken into consideration.

The possible states of each component in the system are assumed to be:

OK=intact; A=failed

First, minimal cut sets of the first order are determined. This means that only one failed component exists in the system, while all other components are intact. The system model is tested, i.e. simulated, for the following combinations (lines):

| B1 | B2 | S1 | S2 | S3 | L1 | L2 |
|---|---|---|---|---|---|---|
| A | OK | OK | OK | OK | OK | OK |
| OK | A | OK | . . . | | | OK |
| OK | OK | A | OK | . . . | | OK |
| . . . | | | | | | |
| OK | OK | OK | . . . | | | A |

Should the system fail for one combination, the procedure will store the failed component of the relevant combination as the minimal cut set of the first order In the present example, no minimal cut sets of the first order appear, since at least two components have to be defect for the entire system to fail.

For a larger system with more components, the table illustrated would comprise a larger number of columns so that a correspondingly larger number of combinations would have to be tested.

Thereafter, minimal cut sets of the second order are determined. This means that there exist two failed components in the system, whereas all other components are intact. The system model is examined for the following combinations (lines). Preferably, each combination is only tested, if the failed components included therein are no proper subset of a minimal cut set already found. An example for this occurs in the determination of minimal cut sets of the third order.

| B1 | B2 | S1 | S2 | S3 | L1 | L2 |
|---|---|---|---|---|---|---|
| A | A | OK | OK | OK | OK | OK |
| A | OK | A | OK | . . . | | OK |
| . . . | | | | | | |
| A | OK | OK | OK | . . . | | A |
| OK | A | A | OK | . . . | | OK |
| OK | A | OK | A | OK | OK | OK |
| . . . | | | | | | |
| OK | OK | OK | OK | OK | A | A |

If the system fails for a combination, the procedure will store the failed components of the relevant combination as a minimal cut set of the second order. In the present example, these are:

### B1 and B2

### B1 and S2

### B2 and S1

### L1 and L2

### S1 and S2

In the following, the determination of minimal cut sets of the third order will be explained. This means that exactly three failed components are present in the system, while all others are operative. Similar to the above, the following combinations (lines) are examined, with each combination being tested only if the failed components included therein are not a proper subset of a minimal cut set already found. Combinations not to be tested are shaded. For example, the first and the second combination are not tested, because the failed components are proper subsets of the minimal cut set B1 and B2.

| B1 | B2 | S1 | S2 | S3 | L1 | L2 |
|---|---|---|---|---|---|---|
| A | A | A | OK | OK | OK | OK |
| A | A | OK | A | OK | OK | OK |
| . . . | | | | | | |
| A | A | OK | OK | . . . | | A |
| A | OK | A | A | OK | OK | OK |
| A | OK | A | OK | A | OK | OK |
| . . . | | | | | | |
| A | OK | A | OK | OK | OK | A |
| . . . | | | | | | |
| OK | A | A | A | OK | OK | OK |
| . . . | | | | | | |
| OK | OK | A | OK | A | A | OK |
| . . . | | | | | | |
| OK | OK | OK | OK | A | A | A |

If the system fails for a combination, the failed components of the relevant combination are stored as a minimal cut set of the third order. In the present example, these are:

### B1 and S3 and L2

### S1 and S3 and L2

### B2 and S3 and L1

### S2 and S3 and L1

In a similar manner, minimal cut sets of higher (>3.) order can also be determined. Generally, however, this is not necessary because of the negligible probability of occurrence.

The following is a detailed explanation of a automated search method for the determination of minimal path sets. Again, the example in FIG. 1 will be used. The procedure is similar to the search method used for minimal cut sets.

Generally, minimal path sets include more intact components that minimal cut sets include failed components. Thus, for a system of N components, the search will be for minimal path sets of the Nth order at most. In the present example, this is the seventh order.

First, minimal path sets of the first order are searched for. This means that exactly one intact component exists in the system, while all others are dysfunctional.

| B1 | B2 | S1 | S2 | S3 | L1 | L2 |
|---|---|---|---|---|---|---|
| OK | A | A | A | A | A | A |
| A | OK | A | . . . | | | A |
| . . . | | | | | | |
| A | A | A | . . . | | | OK |

If the system is functional for one combination, the intact component of the relevant combination will be stored in the procedure as a minimal path set of the first order. In the present case, no minimal path sets of the first order occur, since a functional system would require at least three intact components.

The search for minimal path sets of the second order follows corresponding steps, wherein, preferably, no search is made for intact components that are a proper subset of a minimal path set already found.

In the determination of minimal path sets of the third order performed in a corresponding manner, the following minimal path sets are found and stored:

### B1 and S1 and L1

### B2 and S2 and L2

The search for minimal path sets of the fourth order is performed in a corresponding manner, wherein, preferably, no search is made for intact components that are a proper subset of a minimal path set already found. Combinations not to be tested are shaded in the following table.

| B1 | B2 | S1 | S2 | S3 | L1 | L2 |
|---|---|---|---|---|---|---|
| OK | OK | OK | OK | A | A | A |
| OK | OK | OK | A | OK | A | A |
| OK | OK | OK | A | A | OK | A |
| OK | OK | OK | A | A | A | OK |
| OK | OK | A | OK | OK | A | A |
| . . . | | | | | | |
| A | OK | OK | OK | A | OK | A |
| A | OK | OK | OK | A | A | OK |
| . . . | | | | | | |
| A | A | A | OK | OK | OK | OK |

If the system is functional for a combination, the intact components of the relevant combination are stored as a minimal path set of the fourth order.

In the present example, these are:

### B1 and S1 and S3 and L2

### B2 and S2 and S3 and L1

Minimal path sets of higher order are found in a similar manner. For a system of N components, the search for minimal path sets can be performed to the Nth order at most.

Hereinafter, the calculation of reliability parameters will be briefly described. For the calculation of the probability of the functioning or a failure of a technical system, the minimal path sets or the minimal cut sets found with the respective search method, are orthogonalized following a known inclusion/exclusion method (Poincaré's algorithm). For this purpose, intersections of the first, second order and so on are determined from the minimal cut sets or the minimal path sets, wherein, according to Boole's idempotent law, components occurring several times in the intersections are taken into account only once, respectively. The failure or the functioning probability for the system is calculated from the sum of the probabilities of occurrence of the intersections, where intersections of an odd order are added and intersections of an even order are subtracted.

Generally, the following is true for the probability of a failure or the functioning of a component or an entire system:

p_{functioning}+p_{failure}=1

with the probability p of the respective event.

The probability of occurrence of a minimal cut set MSᵢ is

$$P ( {MS}_{i} ) = {\prod }_{{K}_{i} ∈ {MS}_{i}} {p}_{i} ,$$

with the failure probabilities pᵢ of the components Kᵢ. The system failure probability is calculated from the minimal cut sets using Poincaré's equation:

$$\begin{matrix}{P}_{system failure} ( {p}_{i} ) = P ( {MS}_{1} ⋁ {MS}_{2} ⋁ … ⋁ {MS}_{n} ) \\ = {\sum }_{j = 1}^{n} P ( {MS}_{j} ) - {\sum }_{i = 1}^{n - 1} {\sum }_{j = i + 1}^{n} P ( {MS}_{i} ⋀ {MS}_{j} ) + … + \\ {( - 1 )}^{n + 1} P ( {MS}_{1} ⋀ {MS}_{2} ⋀ … ⋀ {MS}_{n} )\end{matrix}$$

As an alternative, the system failure probability may also be calculated from the minimal path sets:

The probability of the occurrence of a minimal path set MPᵢ is

$$P ( {MP}_{i} ) = {\prod }_{{K}_{i} ∈ {MP}_{i}} ( 1 - {p}_{i} ) ,$$

with the failure probabilities pᵢ of the components Kᵢ. Thus, for the system failure probability, it follows:

$$\begin{matrix}{P}_{system failure} ( {p}_{i} ) = 1 - P ( {MP}_{1} ⋁ {MP}_{2} ⋁ … ⋁ {MP}_{n} ) \\ = 1 - ( {\sum }_{j = 1}^{n} P ( {MP}_{j} ) - {\sum }_{i = 1}^{n - 1} {\sum }_{j = i + 1}^{n} P ( {MP}_{i} ⋀ {MP}_{j} ) + … + \\ {( - 1 )}^{n + 1} P ( {MP}_{1} ⋀ {MP}_{2} ⋀ … ⋀ {MP}_{n} ) )\end{matrix}$$

For the example illustrated in FIG. 1, the following four minimal path sets were found:

### MP₁=B1 & S1 & L1

### MP₂=B2 & S2 & L2

### MP₃=B1 & S1 & S3 & L2

### MP₄=B2 & S2 & S3 & L1

The orthogonalization, i.e. the forming of the intersections, of the minimal path sets with the component failure probabilities inserted, is obtained as follows.

### Intersections of the First Order:

P(MP₁)=(1−p_{B1})(1−p_{S1})(1−p_{L1})

P(MP₂)=(1−p_{B2})(1−p_{S2})(1−p_{L2})

P(MP₃)=(1−p_{B1})(1−p_{S1})(1−p_{S3})(1−p_{L2})

P(MP₄)=(1−p_{B2})(1−p_{S2})(1−p_{S3})(1−p_{L1})

### Intersections of the Second Order:

P(MP₁̂MP₂)=(1−p_{B1})(1−p_{S1})(1−p_{L1})(1−p_{B2})(1−p_{S2})(1−p_{L2})

P(MP₁̂MP₃)=(1−p_{B1})(1−p_{S1})(1−p_{S3})(1−p_{L1})(1−p_{L2})

P(MP₁̂MP₄)=(1−p_{B1})(1−p_{B2})(1−p_{S1})(1−p_{S2})(1−p_{S3})(1−p_{L1})

P(MP₂̂MP₃)=(1−p_{B1})(1−p_{B2})(1−p_{S1})(1−p_{S2})(1−p_{S3})(1−p_{L2})

P(MP₂̂MP₄)=(1−p_{B2})(1−p_{S2})(1−p_{S3})(1−p_{L1})(1−p_{L2})

P(MP₃̂MP₄)=(1−p_{B1})(1−p_{B2})(1−p_{S1})(1−p_{S2})(1−p_{S3})(1−p_{L1})(1−p_{L2})

### Intersections of the Third Order:

P(MP₁̂MP₂̂MP₃)=P(MP₃̂MP₄)

P(MP₁̂MP₂̂MP₄)=P(MP₃̂MP₄)

P(MP₁̂MP₃̂MP₄)=P(MP₃̂MP₄)

P(MP₂̂MP₃̂MP₄)=P(MP₃̂MP₄)

### Intersections of the Fourth Order:

P(MP₁̂MP₂̂MP₃̂MP₄)=P(MP₃̂MP₄)

By inserting numerical values for the failure probabilities p₁ of the components, it is possible to calculate the probabilities of the occurrence of the above intersections.

Further insertion of the orthogonalized minimal path sets and probabilities of occurrence into Poincaré's equation, yields the failure probability of the system:

$${P}_{system failure} ( {p}_{i} ) == 1 - ( P ( {MP}_{1} ) + P ( {MP}_{2} ) + P ( {MP}_{3} ) + P ( {MP}_{4} ) - P ( {MP}_{1} ⋀ {MP}_{2} ) - P ( {MP}_{1} ⋀ {MP}_{3} ) - P ( {MP}_{1} ⋀ {MP}_{4} ) - P ( {MP}_{2} ⋀ {MP}_{3} ) - P ( {MP}_{2} ⋀ {MP}_{4} ) - P ( {MP}_{3} ⋀ {MP}_{4} ) + P ( {MP}_{1} ⋀ {MP}_{2} ⋀ {MP}_{3} ) + P ( {MP}_{1} ⋀ {MP}_{2} ⋀ {MP}_{4} ) + P ( {MP}_{1} ⋀ {MP}_{3} ⋀ {MP}_{4} ) + P ( {MP}_{2} ⋀ {MP}_{3} ⋀ {MP}_{4} ) - P ( {MP}_{1} ⋀ {MP}_{2} ⋀ {MP}_{3} ⋀ {MP}_{4} ) )$$

The marginal importance I_{marg}(i) of a component i describes the probabilistic and structural influence this component has with respect to the occurrence of a system failure. The respective marginal importances may be calculated, for example, with the partial derivatives of the equations for the probability of system functioning:

$${I}_{marg} ( i ) = \frac{\partial {P}_{system functioning} ( {p}_{i} )}{\partial {p}_{i}} . \\ With {P}_{system functioning} = 1 - {P}_{system failure}$$

inserted for the component B1 of the present example, one obtains:

$${I}_{marg} ( B 1 ) = \frac{\partial {P}_{system functioning} ( {p}_{B 1} )}{\partial {p}_{B 1}} == ( 1 - {p}_{S 1} ) ( 1 - {p}_{L 1} ) + ( 1 - {p}_{S 1} ) ( 1 - {p}_{S 3} ) ( 1 - {p}_{L 2} ) - ( 1 - {p}_{S 1} ) ( 1 - {p}_{L 1} ) ( 1 - {p}_{B 2} ) ( 1 - {p}_{S 2} ) ( 1 - {p}_{L 2} ) - ( 1 - {p}_{S 1} ) ( 1 - {p}_{S 3} ) ( 1 - {p}_{L 1} ) ( 1 - {p}_{L 2} ) - ( 1 - {p}_{B 2} ) ( 1 - {p}_{S 1} ) ( 1 - {p}_{S 2} ) ( 1 - {p}_{S 3} ) ( 1 - {p}_{L 1} ) - ( 1 - {p}_{B 2} ) ( 1 - {p}_{S 1} ) ( 1 - {p}_{S 2} ) ( 1 - {p}_{S 3} ) ( 1 - {p}_{L 2} ) - ( 1 - {p}_{B 2} ) ( 1 - {p}_{S 1} ) ( 1 - {p}_{S 2} ) ( 1 - {p}_{S 3} ) ( 1 - {p}_{L 1} ) ( 1 - {p}_{L 2} ) + ( 4 - 1 ) ( 1 - {p}_{B 2} ) ( 1 - {p}_{S 1} ) ( 1 - {p}_{S 2 } ) ( 1 - {p}_{S 3} ) ( 1 - {p}_{L 1} ) ( 1 - {p}_{L 2} )$$

For a calculation of a numerical value of I_{marg}(B1), the failure probabilities pᵢ of the individual components have to be inserted into the above equation. The respective importances of the other components B2, S1, S2, S3, L1 and L2 are calculated by forming appropriate partial derivatives:

$${I}_{marg} ( B 2 ) = \frac{\partial {P}_{system functioning} ( {p}_{B 2} )}{\partial {p}_{B 2}}$$

$${I}_{marg} ( S 1 ) = \frac{\partial {P}_{system functioning} ( {p}_{S 1} )}{\partial {p}_{S 1}}$$

Any structural importances, which merely describe the influence of the respective position of a system component relative to the system failure, can be determined by inserting the equations of the respective marginal importances for all

$${p}_{i} = \frac{1}{2} ,$$

replacing the component failure probabilities

Below it is shown how the simulation based method of the invention for determining the minimum path sets can further be improved.

As already described, the simulation based method evaluates the system model for combinations of operative and failed components in a specific order. The method continues with the determination of minimum path sets by simulating the system model for intact components up to an order of k=n, n being the number of the components of the system.

Apparently, this simulation based method has a character of systematic trial and error. Yet, the computing effort increases significantly with the number of components contained in a system model. For a system model comprising n components, a total of up to N sets (rows) have to be checked by simulations:

$$N \leq {\sum }_{k = 1}^{n} ( \begin{matrix}n \\ k\end{matrix} )$$

An Estimation of Computing Effort is shown below:

| | n | | | | | | | |
|---|---|---|---|---|---|---|---|---|
| | 1 | 2 | 3 | 4 | . . . | 10 | . . . | 20 |
| N | 1 | 3 | 7 | 15 | | 1023 | | 1048575 |

Consequently, this method of minimum path set determination is only practical for systems including relatively few components. On its own, this method is not suitable for analysing an electric system including a large number of components.

So far, the system model is checked only in simulations. A further possibility is to evaluate the object structure of the system model, as described in below.

The following method exploits the object structure of the system model, i.e. the arrangement of components and connections. Advantage is taken of the fact that the structure of object-oriented models is similar, although not exactly identical, to minimum path sets.

Thus, a specific algorithm is devised to analyse the succession of connected components. As a result, the algorithm yields the different paths of consecutive and non-repeating components that exist in a system model. The paths that are determined in this manner are considered as minimum path set candidates.

The fundamentals of this kind of algorithm are described hereafter. It is realised as a recursive model parser in Modelica. In the listing, the notations component1, component2 and path indicate variables.
1. Begin at the FailureTopEvent gate of the system model and add it as component1 to the path.
2. Find all components connected to component1.
3. If no components are connected to component1 then terminate the actual recursion branch.
4. If one component is connected to component1 then take it as component2 and continue with the actual recursion branch,
5. else if more than one components are connected to component1 then start a new recursion branch for each component taken as component2, respectively.
6. If component2 is not contained in path yet then add component2 to path and resume at step 2 taking component2 as the next component1,
7. else terminate the actual recursion branch.

The result of this system model object structure analysis are paths that are considered as minimum path set candidates. Therefore, these candidates are checked by simulating the system model accordingly, to eventually extract the minimum path sets from the list of candidates.

In this method, the system model is simulated for each candidate, such that the components belonging to a candidate are switched to the intact mode one after another, while all other components of the system are failed. System operation or failure is detected in the simulation by evaluating the logical signal FailureTopEvent. If the system operates, then the causing set of intact components is stored as a minimum path set.

The number of path candidates to be checked in the simulation is limited, hence conducting an object structure analysis first and then simulation minimises the overall computing effort. Thus, the combination of both leads to a reliability analysis procedure that is viable even for large systems with many components.

Although the invention has been described and illustrated with reference to specific embodiments thereof, it is not intended that the invention be limited to those illustrative embodiments. Those skilled in that art will recognize that variations and modifications can be made without departing from the true scope of the invention as defined by the claims that follow. It is therefore intended to include within the invention all such variations and modifications as fall within the scope of the appended claims and equivalents thereof.

1. A method for analyzing and/or optimizing technical systems, comprising the following steps:
modeling a technical system using a software model,
determining for all relevant combinations of functional and/or failed individual components of the technical system, whether an orderly functioning or a failure of the entire technical system exists, the determination being performed automatically using the software model established,
determining the individual failure probabilities of the components of the technical system,
calculating a total failure probability for the technical system based on the individual failure probabilities of the components of the technical system and on the determined functioning/failure of the entire technical system for the respective functional and/or failed circuit components.

2. The method of claim 1, further comprising the step of:
calculating the importances of the individual components of the technical system.

3. The method of claim 1, wherein the calculation of the total failure probability is based on the calculations of a minimal cut set analysis, especially an automated minimal cut set analysis.

4. The method of claim 1, wherein the calculation of the total failure probability is based on the calculations of a minimal path set analysis, especially an automated minimal path set analysis.

5. The method of claim 3, wherein the minimal cut set analysis comprises the step of
determining all relevant, especially all possible combinations of failed individual components of the entire technical system that lead to a failure of the entire technical system, the determination of the functioning/failure of the entire technical system preferably being done following a trial-and-error method.

6. The method of claim 5, wherein the minimal cut set analysis comprises the step of
calculating the probabilities of the occurrence of the determined combinations of failed individual components that would cause a failure of the technical system, based on the known failure probabilities of the individual components.

7. The method of claim 4, wherein the minimal path set analysis comprises the step of
determining all possible combinations of functional individual components of the technical system that lead to the functioning of the entire technical system, the determination of the functioning/failure of the entire technical system preferably being done following a trial-and-error method.

8. The method of claim 7, wherein the minimal path set analysis comprises the step of
calculating the probabilities of the occurrence of the determined combinations of functional individual components that would cause the functioning of the technical system, based on the known failure probabilities of the individual components.

9. The method of claim 1, wherein establishing the model of the technical system is done using a physical and object-oriented modeling software, the object limits and the connections between the objects in the software model preferably corresponding to the actual individual components and their connections.

10. The method of claim 1, wherein the minimal cut set analysis and/or the minimal path set analysis is executed in an automated manner by an analysis software which preferably has an interface to the software model of the technical system.

11. The method of claim 9, wherein the object-oriented software for establishing the software model of the technical system has a graphical user interface for the visual representation of the modeled technical system.

12. The method of claim 11, wherein the software model of the technical system and in particular of the individual components can be modified preferably via the graphical user interface.

13. The method of claim 12, wherein, upon a modification of the software model of the technical system, a recalculation of the minimal cut set analysis and/or the minimal path set analysis, as well as a new execution of the steps following the minimal cut set analysis and/or the minimal path set analysis is effected automatically, preferably initiated by the user.

14. The method of claim 13, wherein, for each modification of the software model of the technical system, a new total failure probability of the technical system is automatically calculated, preferably initiated by the user.

15. The method of claim 1, further comprising the step of:
determining a total mass of the technical system from the individual masses of the individual components of the technical system, the determination of the total mass being effected preferably automatically by the software for modeling the technical system.

16. The method of claim 1, further comprising the step of:
determining the physical behavior of the technical system, the determination of the physical behavior preferably being done automatically by the software for modeling the technical system.

17. A method for optimizing an electric on-board network of an aircraft by the for analyzing and/or optimizing technical systems of claim 1.

18. A data carrier with software for executing the method of claim 1.
